(19) United States
(12) Patent Application Publication
(10) Pub. No.: US 2010/0131866 A1
(43) Pub. Date: May 27, 2010

(54) METHOD AND SYSTEM FOR WEB-BASED TELECONFERENCING

(76) Inventors: Rob Nielsen, Ottawa (CA); Tomasz Tomaszewski, Ottawa (CA); Noam Tomczak, Toronto (CA); Alec Saunders, Manotick (CA); Howard Thaw, Halifax (CA)

Correspondence Address: HAYES SOLOWAY P.C., 3450 E. SUNRISE DRIVE, SUITE 140, TUCSON, AZ, 85718, US

(21) Appl. No.: 12/557,957

(22) Filed: Sep. 11, 2009

Related U.S. Application Data
(60) Provisional application No. 61/096,280, filed on Sep. 11, 2008.

(51) Int. Cl. H04L 12/16; G06F 3/048

(52) U.S. Cl. 715/758; 370/261; 715/835

(57) ABSTRACT

A system enables web-based teleconferencing. The system uses a voice services router connected to phone devices associated with respective web browser clients. The system also uses an application server connected to the voice services router for receiving conference call events for a conference call from the voice services router and for transmitting the conference call events to a message server. The application server is furthermore connected to the web browser clients associated with the phone devices for receiving conference commands from the web browser clients and for transmitting the conference commands received from the web browser clients to the voice services router. The message server is connected to both the application server and the web browser clients to thereby act as a message broker for receiving messages from the application server for the conference call and for communicating the messages for the conference call to the web browser clients.

### CROSS-REFERENCE TO RELATED APPLICATIONS

This application claims priority to U.S. Provisional Application Ser. No. 61/096,280, filed Sep. 11, 2008, which is entirely incorporated herein by reference.

### TECHNICAL FIELD

The present invention relates generally to telecommunications and, in particular, to teleconferencing.

### BACKGROUND

Conventional audio teleconferencing involves connecting three or more callers on a conference call. The conference call can be initiated by a moderator who calls all of the parties one by one, adding them to the call sequentially, or accomplished using a dial-in number and access code that every party calls. Teleconferencing typically requires a conference bridge, i.e. equipment within a service provider or carrier for connecting multiple callers together.

While traditional teleconferencing technology is relatively easy for phone users to set up, it only provides good interactivity in small groups; for larger groups, it can be cumbersome, thus inhibiting collaboration and interaction. Furthermore, many conventional conferencing solutions offer only limited and unsophisticated in-call functions. Moreover, many people consider that audio-only presentations are not engaging. Although video-conferencing and web seminar technologies (voice combined with web-based slide shows) are more engaging than audio-only presentations, these too suffer from a number of drawbacks in that they limit participant interactivity and offer only a limited number of in-call features. Therefore, an improvement on these conventional forms of teleconferencing remains highly desirable.

### SUMMARY

The present invention provides a novel method of using a website such as, for example, a social networking website such as, for example, Facebook®, to perform web-based teleconferencing. A variety of teleconferencing features can be controlled through a web interface rather than using the phone device itself. For example, signalling the joining or departure of a party, muting or “un-muting” of a party, signalling that a party wishes to speak, signalling that the teleconference is being recorded and/or transcribed, can be performed using the web interface of the website, for example, a modified web interface of a social networking website. For example, various icons can be displayed on the web interface to signal the activation or deactivation of various conferencing features. In addition, the web interface of the website (e.g. the social networking website) can be used for posting messages in the chat area of the interface. By adding these functions to a website or to an existing social networking website, the teleconferencing experience is greatly improved. Some of the recurring problems associated with conventional teleconferencing solutions can be obviated, such as, for example, the inherent difficulty of managing parties wanting to speak, audibly signalling the arrival or departure of parties (which interrupts the call with a beep, sound or verbal statement). In addition to addressing these problems, this novel technology provides a number of highly useful conferencing features such as, for example, a chat interface. When superimposed on an existing social networking website, this technology provides a number of interesting and innovative features, such as, for example, the ability to engage the other parties to the conference call in a manner that was hitherto not possible (by chatting, consulting their online bios, personal profiles, recent information posted, etc.)

In accordance with one main aspect of the present invention, a method of providing web-based teleconferencing involves connecting phone devices to a voice services router for a conference call, the phone devices being associated with respective web browser clients, communicating conference call events for the conference call from the voice services router to an application server, communicating messages pertaining to the conference call events from the application server to a message server connected to both the application server and to the web browser clients, communicating the messages pertaining to the conference call events to the web browser clients, receiving at the application server one or more conference commands from the web browser clients, and communicating the one or more conference commands from the application server to the voice services router.

In accordance with another main aspect of the present invention, a system enables web-based teleconferencing. The system has a voice services router connected to phone devices with which are associated respective web browser clients. The system also has an application server connected to the voice services router for receiving conference call events for a conference call from the voice services router and for transmitting the conference call events to a message server, the application server furthermore connected to the web browser clients associated with the phone devices for receiving conference commands from the web browser clients and for transmitting the conference commands received from the web browser clients to the voice services router. In this system, the message server is connected to both the application server and the web browser clients to thereby act as a message broker for receiving messages from the application server for the conference call and for communicating the messages for the conference call to the web browser clients.

In accordance with yet another main aspect of the present invention, a computer program product has code which when loaded into memory and executed on one or more processors of one or more computing devices is adapted to perform steps of communicating conference call events for a conference call from a voice services router to an application server, the voice services router being connected to phone devices, the phone devices furthermore being associated with respective web browser clients, communicating messages pertaining to the conference call events from the application server to a message server connected to both the application server and to the web browser clients, communicating the messages pertaining to the conference call events to the web browser clients, receiving at the application server one or more conference commands from the web browser clients, and communicating the one or more conference commands from the application server to the voice services router.

### BRIEF DESCRIPTION OF THE DRAWINGS

Further features and advantages of the present technology will become apparent from the following detailed description, taken in combination with the appended drawings, in which:

FIG. 1 is a schematic depiction of a system for web-based teleconferencing in accordance with an embodiment of the present invention;

FIG. 2 schematically depicts the system data flow when a conference call is set up using the system of FIG. 1;

FIG. 3A is a screenshot of an example web interface for displaying the identity of participants to the conference call and for providing controls for conferencing features;

FIG. 3B is a screenshot of the example web interface presented in FIG. 3A after a second participant has joined the conference call;

FIG. 4 schematically depicts the system data flow when a participant chooses to mute his line during a conference call;

FIG. 5A is a screenshot of an example web interface that provides an icon for muting a line;

FIG. 5B is a partial screenshot of the example web interface of FIG. 5A after one of the participants has muted his line;

FIG. 6 schematically depicts the system data flow when a participant hangs up (leaves the conference call);

FIG. 7A is a screenshot of an example web interface that provides information about the current participants to the conference call;

FIG. 7B is a screenshot of the web interface after one of the participants has left the conference call;

FIG. 8 schematically depicts the system data flow when a hand is raised from the phone;

FIG. 9 schematically depicts the system data flow when a hand is raised from the web browser client;

FIG. 10 presents two screenshots of an example web interface showing the dynamic changes to the interface when a user raises his hand;

FIG. 11 schematically depicts the system data flow when a user initiates recording from the web browser client;

FIG. 12 presents screenshots of how the interface changes when recording is initiated;

FIG. 13 schematically depicts the system data flow when a user initiates recording from the phone device;

FIG. 14 schematically depicts the system data flow when the system detects who is talking;

FIG. 15A is a screenshot of an example invitation to a conference call;

FIG. 15B is a screenshot of an example acceptance screen for accepting/declining the invitation to the conference call;

FIG. 15C schematically depicts the system data flow when invitations are sent and accepted;

FIG. 16 are screenshots showing example interfaces during a conference call setup;

FIG. 17 schematically depicts the system data flow for live chat;

FIG. 18 are screenshots showing example chat interfaces;

FIG. 19 schematically depicts the system data flow for muting a line from the phone device;

FIG. 20 are screenshots showing how the interfaces are updated when a line is muted;

FIG. 21 schematically depicts the system data flow for muting and then un-muting a line using the web browser client; and

FIG. 22 are screenshots showing how the interfaces are updated when a line is muted and then un-muted.

It will be noted that throughout the appended drawings, like features are identified by like reference numerals.

### DETAILED DESCRIPTION

In general, and as will be elaborated below, this new technology enables web-based teleconferencing in which conferencing features are controlled by web browser clients associated with each of the phone devices connected to the conference call. The web browser clients associated with each of the phone devices can be used to display information about each of the parties to the conference call (e.g. whether they are participating in the call, whether they wish to verbally interject a comment, whether they've left the call, whether they've muted their line, etc.)

Thus, the present invention provides a novel system, method and computer program product for enabling web-based teleconferencing. This technology can be utilized to configure a dedicated website to provide desired conferencing functionalities or, alternatively, it can be added to an existing website, such as, for example, an existing social networking website like Facebook®. In one main implementation of this technology, conference calling is built on Facebook® Platform (a platform that enables third-party developers to build applications that interact with Facebook®). In other words, in its main implementation, this technology provides an audio-conferencing platform grafted onto a social networking website such as Facebook®.

The preferred embodiments of the present invention will now be described below, by way of example, with reference to the attached drawings.

System Overview

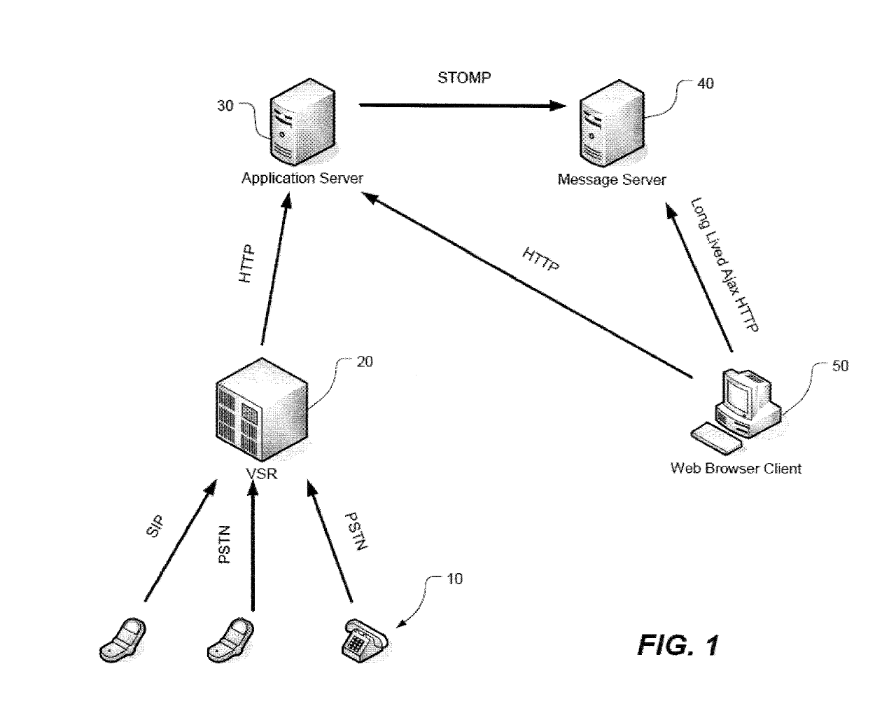

FIG. 1 is a schematic depiction of a system for web-based teleconferencing in accordance with an embodiment of the present invention.

As depicted in FIG. 1, the system has a voice services router 20 connected to phone devices 10 with which are associated respective web browser clients 50. In other words, each participant in the conference call has both a phone device and a web browser client. The phone devices 10 can be connected to the voice services router via the internet (e.g. VoIP or SIP phones) or via the PSTN (e.g. regular landlines or mobile/cellular phones).

As further depicted in FIG. 1, the system also has an application server 30 connected to the voice services router 20 for receiving conference call events for a conference call from the voice services router 20 and for transmitting the conference call events to a message server 40. The application server 30 is furthermore connected to the web browser clients 50 associated with the phone devices 10 for receiving conference commands from the web browser clients 50 and for transmitting the conference commands received from the web browser clients 50 to the voice services router 20. The message server 40 is connected to both the application server 30 and the web browser clients 50 to thereby act as a message broker for receiving messages from the application server 30 for the conference call and for communicating the messages for the conference call to the web browser clients 50.

Using the system architecture presented in FIG. 1, participants can engage in a conference call using their respective phone devices 10 while viewing on a web interface various pieces of information about aspects of the conference call (who is participating, whether the call is being recorded, who has muted his line, etc.). This same web interface on the web browser clients 50 furthermore provides a number of icons or graphical elements for controlling various conference features, e.g. muting or un-muting a line, sending a request to intervene or interject a comment (“raising your hand”), engaging in chatting with other participants, etc.

In one embodiment, each web browser client presents a web interface depicting one or more icons for muting and un-muting the line. The user who wishes to mute (or un-mute) a line thus can click on a mute (or un-mute) icon depicted onscreen. The status (muted/un-muted) can also be shown on the same screen.

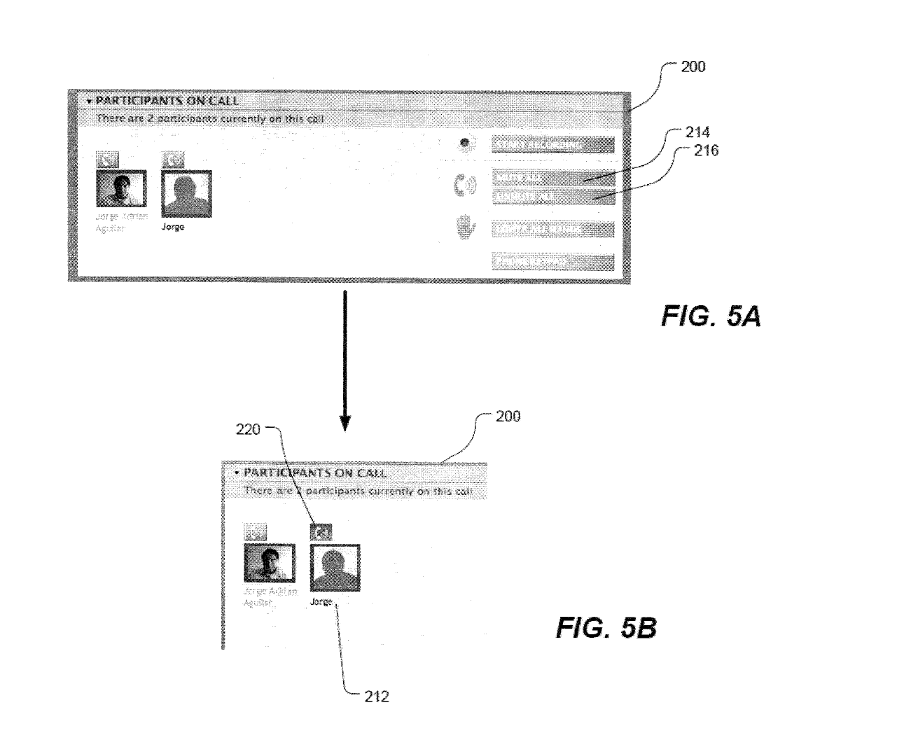

In another embodiment, each web browser client presents a web interface depicting one or more icons for recording the conference call (“Start Recording”, as shown in FIG. 5A). The web interface can also present an indication that the call underway is being recorded.

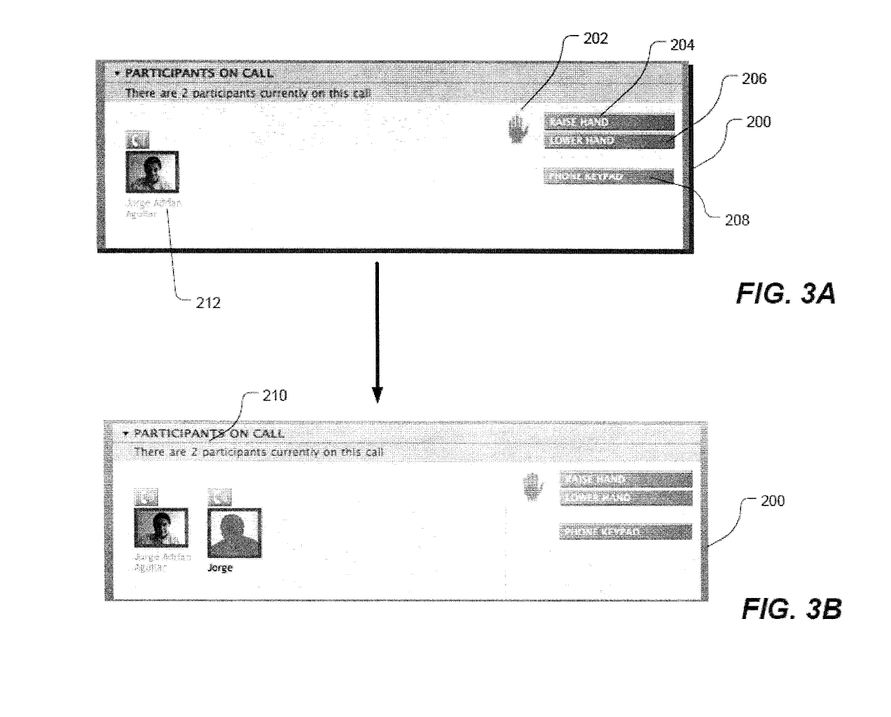

In another embodiment, the web browser client presents a web interface depicting one or more interjection icons for signalling that a party wishes to speak. This interjection icon may be a hand icon that can be raised or lowered to signal one's desire to speak or to interject a comment. For example, as shown by way of example in FIG. 3A, buttons or icons labelled “Raise Hand” and “Lower Hand” can be provided to enable a participant to indicate to the others on the call that he or she wishes to speak. (The “Lower Hand” button enables the user to retract or cancel the request to speak, and thus cancels (lowers) the “raised hand”.)

In one embodiment, the web browser client provides a chat interface for enabling parties to the conference call to exchange instant messages. This is particularly useful for participants who wish to engage is side discussions without disrupting the current speaker. By grafting this technology onto an existing social networking website, users can interact using all of the pre-existing features of the social networking site while engaged in the conference call. This substantially improves the interactivity amongst the participants.

The specific attributes of the voice services router 20, application server 30, message server 40 and web browser client 50 will be described below in greater detail.

Voice Services Router (20)

The voice services router (VSR) has the capability to send phone and conference call events to other servers through HTTP, and use the response to take action in the conference call. The voice services router may be, for example, a VSR 1000 from ThinkEngine Networks or any equivalent equipment. In other words, the VSR can be replaced by any other advanced conference bridge having the ability to transmit and receive conference events/commands to and from another device or server.

The VSR 1000 also has a built in HTTP server that can receive conference commands from other servers and take actions for a conference call.

Phone devices connect to the VSR 1000 through the Public Switch Telephone Network (PSTN) or SIP (Session Initiation Protocol) via the public internet.

The VSR 1000 handles all media mixing and DTMF handling for all phones connected to it.

Application Server (30)

The Ruby on Rails server serves HTML, CSS and JavaScript to the browser providing the user interface and database access for the application.

All the business Logic used to run a conference call resides in the Rails Application instead of the conference switch. This allows for rich integration of conference features into a web-based application.

The Rails server receives conference commands from the web browser, processes those commands and sends conference commands to the VSR 1000 via HTTP.

It also receive conference call events from the VSR 1000 processes those publish them to the ActiveMQ server.

Message Server (40)

The ActiveMQ server acts as a message broker. ActiveMQ receives messages from the Rails server for a specific conference call. ActiveMQ publishes that message to all web browser clients that are connected to it and registered to listen for that conference call.

Web Browser Client (50)

The web browser receives HTML, CSS and JavaScript from the Rails server.

The JavaScript client running in the browser maintains a long lived AJAX HTTP connection to the ActiveMQ server. When the connection times out a new one is started, that way the browser is always connected to the ActiveMQ server.

It receives both JavaScript commands and html from ActiveMQ encoded in an XML document. It parses the XML and takes through JavaScript and DHTML updates the web page without refreshing the page.

Using this technique, live conference events are reflected in the web page almost instantly and without having to ever refresh the browser.

In another embodiment, the web browser could be replaced by any software application that is able to connect to a server through the Internet and provide a user interface for the user to control the conferencing features.

In the foregoing example, discrete components 20, 30, are used to implement this technology. In another variation, the technology may be implemented by amalgamating two or more of these components into a single multi-function device.

Method

This technology also provides a novel method of performing web-based teleconferencing. This novel method entails connecting phone devices 10 to a voice services router for a conference call, the phone devices 10 being associated with respective web browser clients 50. The method further includes communicating conference call events for the conference call from the voice services router 20 to an application server 30. Messages pertaining to the conference call events are communicated from the application server 30 to a message server 40 connected to both the application server 30 and to the web browser clients 50. Messages pertaining to the conference call events are then communicated to the web browser clients 50. The application server 30 receives one or more conference commands from the web browser clients 50. The one or more conference commands from the application server 30 are communicated to the voice services router 20.

Conference Call Setup: Overview

In order to set up a conference call, the method described above is preceded by initial conference call setup steps of receiving a phone call from a party wishing to join the conference call at the voice services router 20, prompting the party wishing to join the conference call for a conference call access code, receiving and transmitting the conference call access code to the application server 30 for validation of the access code. If the access code is validated, transmitting a new caller joining signal to the message server 40 which communicates the new caller joining signal to the web browser clients 50.

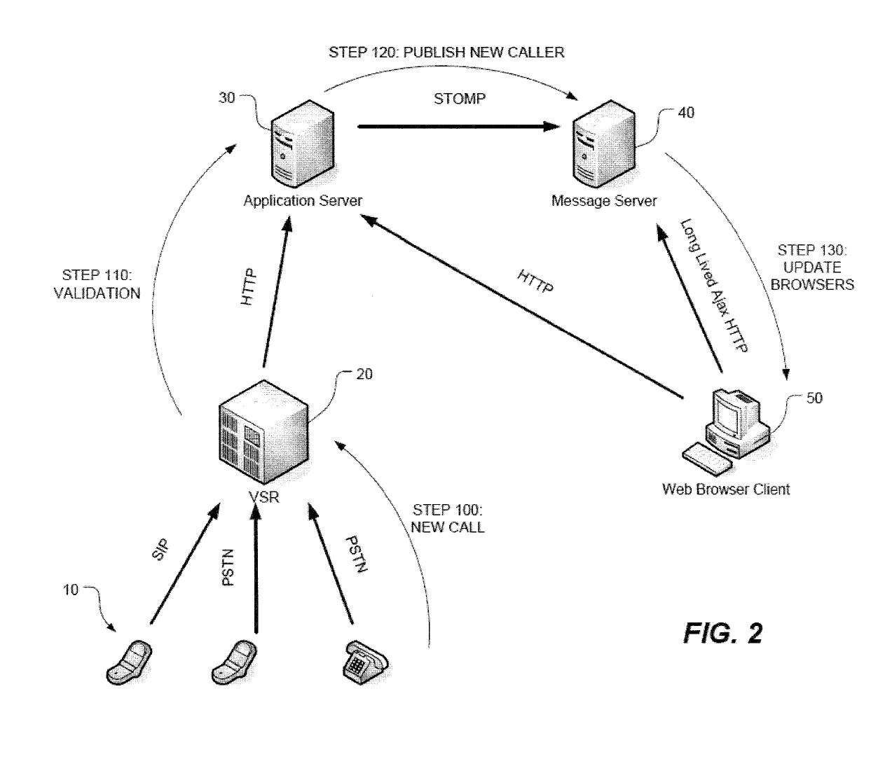

FIG. 2 schematically depicts the system data flow when a conference call is set up using the system of FIG. 1 (i.e. according to the method outlined in the preceding paragraph).

1. At step 100, a phone call is received at the VSR. The Call Flow in the VSR prompts the user for their identifier (access code) to join the conference call. The identifier is either their personal PIN code for the call or a phone number they saved in the web application.

2. At step 110, the identifier is sent to the application server via HTTP for validation. The application server determines if the identifier is valid. The application server either returns a conference call ID to the VSR or a failure code.

3. At step 120, if the identifier was validated by the application server, the caller is then published by sending this new caller information (about the caller who is now joining the conference) to the message server (e.g. ActiveMQ server) using the STOMP protocol.

4. At step 130, the message server (e.g. the ActiveMQ server) returns the XML provided by the application server to all the web browser clients (e.g. all the JavaScript clients) registered to listen for events of that specific conference call. The web browser client (e.g. the JavaScript client) then updates the web page to reflect that the new caller has joined the conference call.

Setting up a Call: Example

In a main implementation of this technology, which is presented by way of example, a conference call setup can be completed through a user interface in a web browser or in a native computer program. One or more call organizers pick the time of the call, a subject and an agenda. They choose the contacts they would like to invite to the call. These contacts can be stored in an address book, e.g. an address book that is specially designed to work with Facebook, a Facebook friend list, their mobile phone or any other address book accessible by the application.

The call organizer has the option to make the conference call public or private. If the call is public, it can be found in a public call directory in the novel system and joined by anyone. If the call is private, only people invited to the call can join and see the conference call in the application. Many other variants of this permission scheme are possible. For example, a caller may be designated as “private” but nonetheless “open” for invited participants to invite other people. A call can be publicly viewable but only people who are invited can join in the call.

Call Invitations: Example

Participants are sent an email containing all the conference call information including subject, agenda, start time, duration and call-in number and their personal PIN code. The invitation also includes a link to a web page from which they can participate in the web portion of the conference call.

The invitation may also include an iCal document included directly in the body of the email message. This allows for email clients that implement the iCal standard to treat the email invitation as a meeting request. This provides extra features to the participant and organizer. For example, the participant can RSVP to the call by clicking the “Accept”, “Decline” or “Tentative” buttons in their email client. This response is parsed by the application and the participant's RSVP status is updated accordingly. The participant can also include a message to the organizer as part of the RSVP from their email client. This novel technology can then deliver that message to the call organizer. This provides a rich integrated experience with any email client without having to have programming code running inside those clients, for example, as a Microsoft Outlook Plug-in.

Invitations can also be sent to the social networking site's users (e.g. Facebook users) through an API provided by the social networking site (e.g. Facebook), thus further integrating into the novel conferencing solution into the social network application.

Personal PIN Codes: Example

A unique feature of this novel conference call application is that every participant that joins a conference call is uniquely identified. This enables the application to show participants of the call in a web page who have joined and who have not yet joined the call. This can be achieved in two ways. One way is that every participant is assigned a personal PIN code for every conference call in which they are a participant. The second is that every user of the system can save phone number they own as their permanent PIN code for every conference call.

The novel application may contain a pool of person participant PIN codes. When a person is invited to a call they are assigned an available PIN code from the pool. Once their call has ended the PIN code is released from the participant and returned to the pool of available PIN codes so that it can be reused. This allows the This novel technology application to assign individual PIN codes to participants without running out of PIN codes.

The application also allows for users to save one or more phone numbers that they own, for example the number of their mobile phone. These phone numbers are used to uniquely identify them and can be used to join any conference call they are participating in. When the system detects that a user is trying to join a conference call using their phone number as their PIN code the application finds all their conference calls that are currently active. An active conference call is defined by a call that the start time is less than 15 minutes in the future and the end time is less than 15 in the past. 15 minutes was chosen because it made conceptual sense but it could be any fixed amount of time.

Joining the Call: Example

A unique feature of the application is that it will recognize the call ID of a calling into the conference switch. If the caller id matches the phone number of a user and the user has an active conference call the user will be automatically joined into their conference without having to enter their PIN code. This significantly eases the process of joining a call.

Conference Call Roles

There are many different roles people can play during a conference call. Some of the basic roles are organizer, moderator and participants. The organizer creates the call and invites the participants. The moderator moderates the call using the conference controls provided by the application. Participants contribute the call through the audio conference and by posting chat messages and raising their hands. Currently there are only two roles implemented in the application for this novel technology. The organizer and moderator are combined into a single role and everyone else is a participant. But the system is designed to allow for a plethora of roles with different permissions and features. For example, there may be a special role for the host of the conference and any special guests. These people may have a special spot in the web page where they are displayed.

Optional Features

The application could show which participant of a conference call is talking. The conference switch has the ability to track whether individual participants on the call are talking and send that information to the application server. That would be published to all the JavaScript clients connected for that call.

This technology can integrate document and desktop sharing providing a rich collaboration sweet. Documents can be shared in the web page, allowing participants to follow along as presenters go through a power point presentation and or other document.

This technology will provide participants a means for indexing key portions of the recording during the call. When the call recording is being listened to as an mp3 file users will be able to skip directly to the flagged section.

This technology will allow call organizers to create recurring calls on a regular schedule.

FIG. 3A is a screenshot of an example web interface 200 for displaying the identity of participants to the conference call and for providing controls for conferencing features. The name/identity 212 of each participant(s) already on the call is shown, with their digital picture if available. The total number of participants may be specified by a participant tally 210.

FIG. 3B is a screenshot of the example web interface presented in FIG. 3A after a second participant has joined the conference call. The page (web interface) 200 in the web application is dynamically updated when a new caller joins the conference call by adding that participant's name and/or photo. The identity/name/photo 212 of each new caller joining the conference call is added dynamically to the web interface each time a new party joins the call without requiring that the browser be refreshed.

FIGS. 3A and 3B depict, by way of example, a number of buttons or icons (or graphical elements) for controlling conference features. For example, a hand icon 202 can be shown to indicate that a participant wishes to speak. “Raise Hand” and “Lower Hand” controls/buttons 204, 206 can be provided to enable the participant to signal a desire to speak or to withdraw that signal. A phone keypad button 208 can be provided to enable the user to view a phone keypad for dialing numbers.

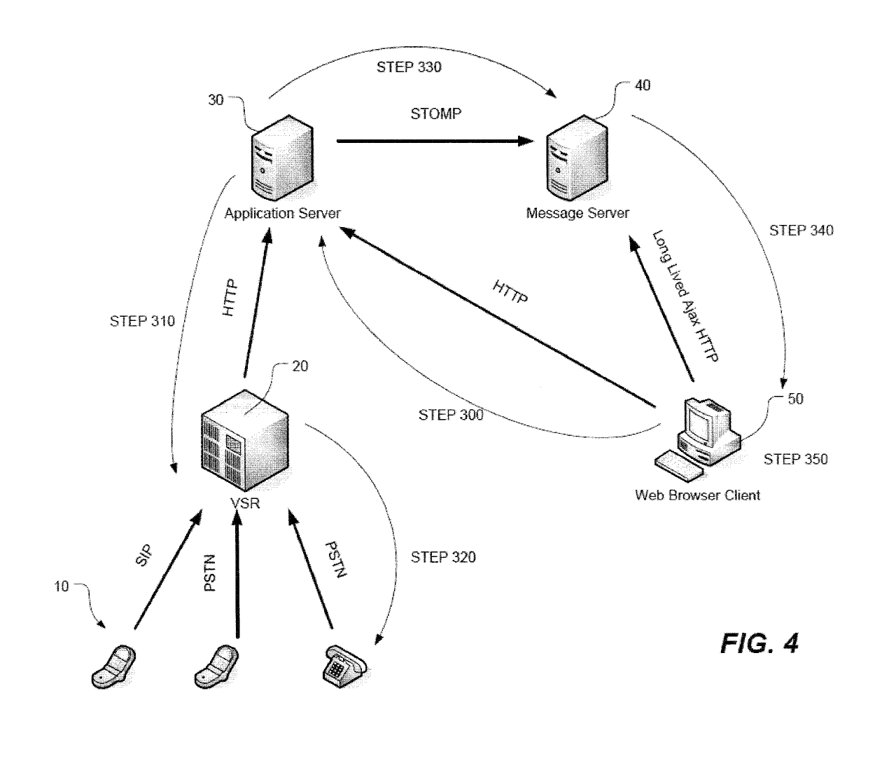

FIG. 4 schematically depicts the system data flow when a participant chooses to mute his line during a conference call. The process of muting a line involves receiving user input on a muting icon depicted on a web interface of the web browser client 50, thus constituting a mute command, communicating the mute command to the application server 30, communicating the mute command from the application server 30 to the voice services router 20, communicating a message pertaining to the mute command from the application server 30 to the message server 40, and communicating the message pertaining to the mute command to all web browser clients 50 associated with the conference call. As shown in FIG. 4, the muting process is initiated at step 300 when a caller clicks the phone icon in the conferencing web page. An Ajax request is sent to the application server. At step 310, application server sends a “mute” command to the VSR. At step 320, the VSR will signal to the user (e.g. audibly through the phone device) that his line has now been muted. At step 330, the application server 30 (e.g. Ruby on Rails) will publish that the caller has muted his line to the ActiveMQ server (message server 40) via STOMP. At step 340, the ActiveMQ server (message server 40) will publish to all connected clients (web browser clients 50) listening for conference call events pertaining to the conference call. At step 350, the JavaScript clients (web browser clients 50) listening to events of this conference will update their respective web pages to indicate that the caller has muted his line.

FIG. 5A is a screenshot of an example web interface that provides icons 214, 216 for muting and un-muting one or more lines.

FIG. 5B is a partial screenshot of the example web interface 200 of FIG. 5A after one of the participants has muted his line. As an example, the caller who muted his line can have a red “X” (designated by reference numeral 220) through their phone icon above their picture/name 212. Other indications or muting symbols can be used instead to represent that the particular participants has muted his line.

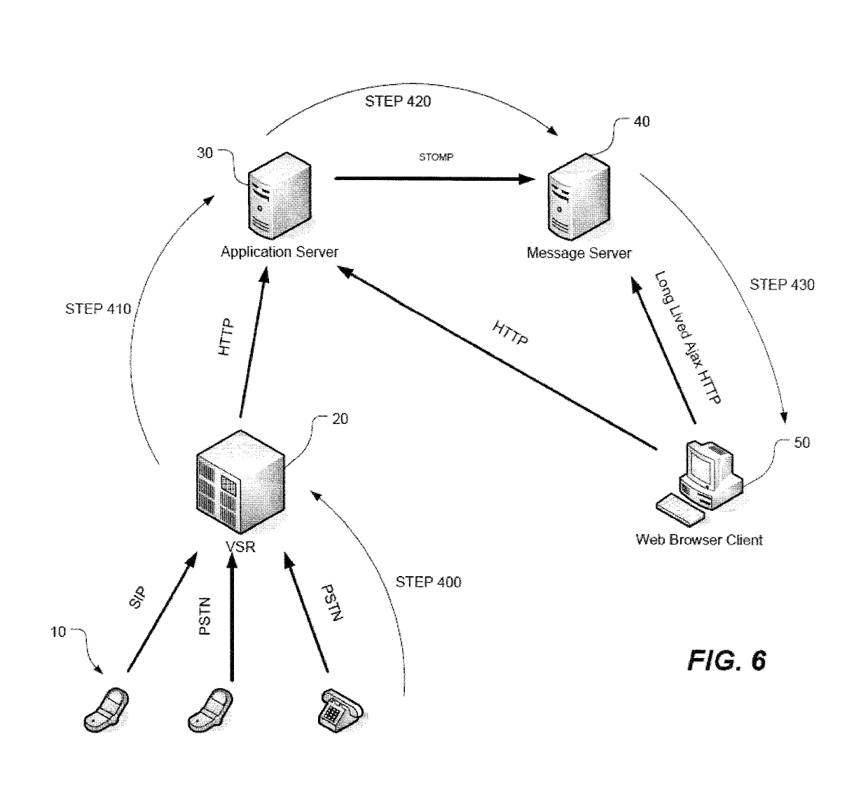

FIG. 6 schematically depicts the system data flow when a participant hangs up (leaves the conference call). These “call-dropping” steps may entails detecting at the voice services router 20 that a phone device 10 connected to the conference call has hung up, thus constituting a call-termination event. Subsequently, the call-termination event is communicated to the application server 30 for, in turn, communicating a message pertaining to the call-termination event from the application server 30 to the message server 40. The message pertaining to the call-termination event is then communicated to all the web browser clients 50 associated with the conference call. The departure of a participant is thus reflected by automatically updating the screen on each web browser. As shown in FIG. 6, the call termination process is triggered (at step 400 when one of the participants on the conference call hangs up, i.e. terminates his call by hanging up his phone device 10). At step 410, the VSR 20 (e.g. VSR 1000) sends the event to the application server 10 (e.g. Rails server) via HTTP. At step 420, the application server 30 (e.g. the Rails server) will publish that the caller has left the conference to the message server 40 (e.g. the ActiveMQ server) via STOMP. At step 430, the message server 40 (e.g. the ActiveMQ server) returns the XML provided by the application server 30 (e.g. the Ruby on Rails server) to all the web browser clients 50 (e.g. JavaScript clients) who are registered to listen for conference call events for that specific conference call. Each JavaScript client then updates its respective web page to reflect the departure of the participant.

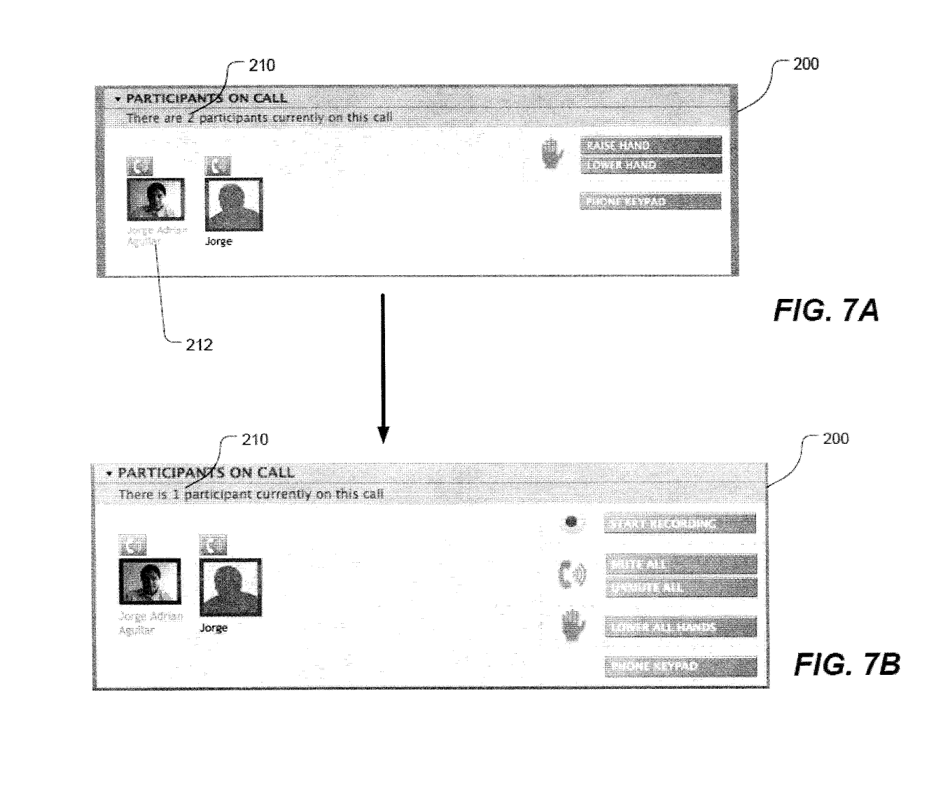

FIG. 7A is a screenshot of an example web interface that provides information about the current participants to the conference call. For example, as described earlier, the total number of participants may be indicated with a tally 210. The identities/photos 212 of the participants can be shown as well.

FIG. 7B is a screenshot of the web interface after one of the participants has left the conference call. The page in the web application is dynamically updated when a caller leaves the conference call. After updating, the tally 212 is changed to reflect the departure. The identities/names of the participants can also be updated to show only the parties remaining in the conference call.

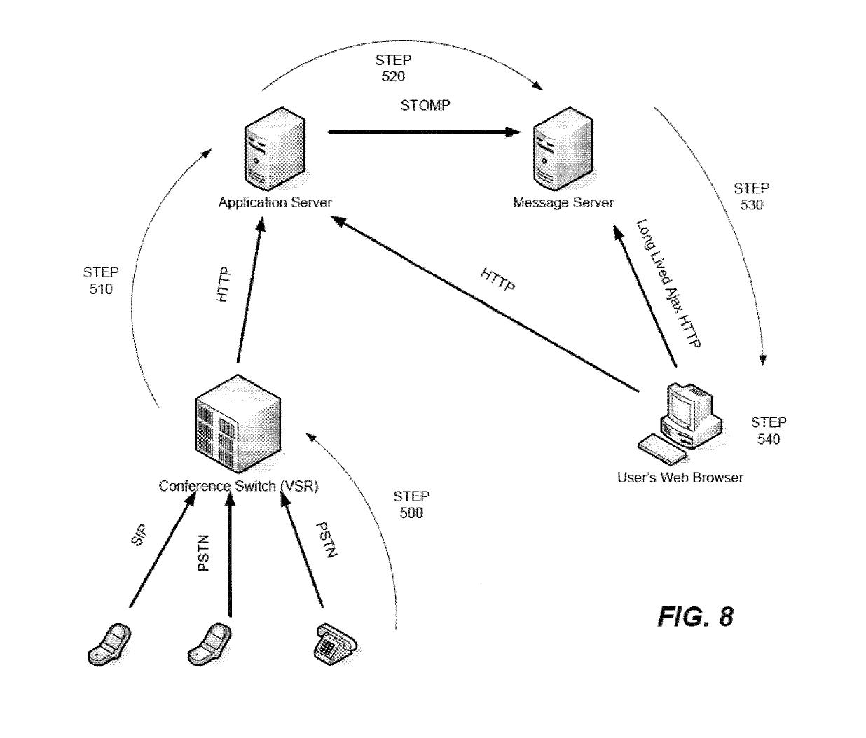

FIG. 8 schematically depicts the system data flow when a hand is raised from the phone. As depicted by way of example, the process of raising one's hand (signalling that one wishes to speak) can involves the following steps: At step 500, a caller on a conference call presses “*2” (or anything other predetermined key combination) on their phone. At step 510, the DTMF tones are caught by the conference switch and sent to the Rails server via HTTP. At step 520, the application server processes the “*2” determining that the caller has raised their hand. The application server publishes to the message server that the caller has raised their hand. At step 530, the message server returns the xml provided by the application Server to all the JavaScript clients registered to listen for events of that specific conference call. At step 540, the JavaScript client then updates the web page to reflect that the caller has raised their hand.

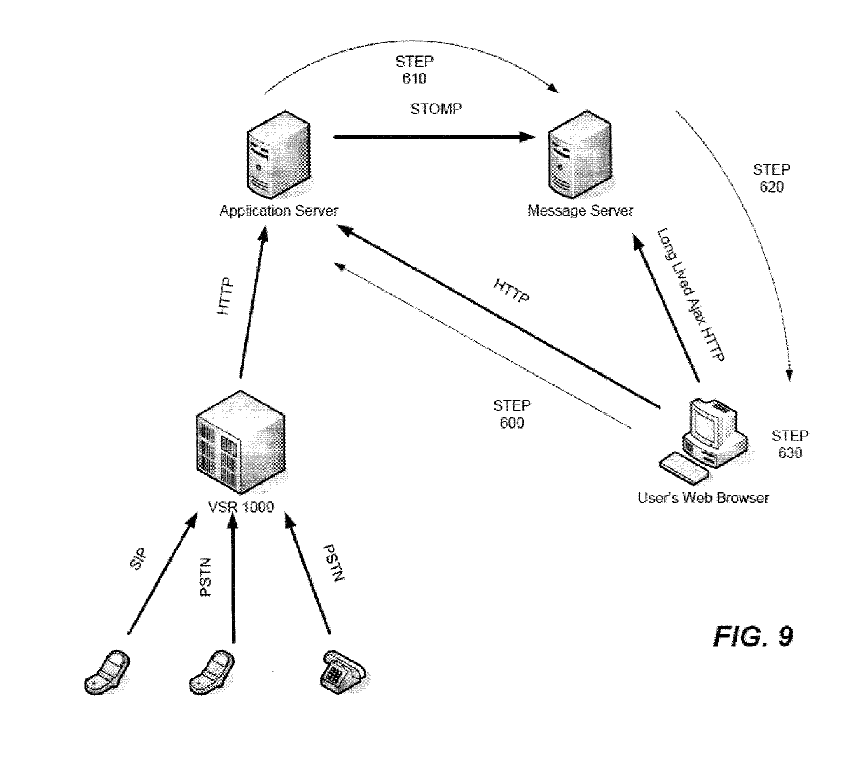

FIG. 9 schematically depicts the system data flow when a hand is raised from the web browser client. As depicted in FIG. 9, the step of signalling an intention to speak can be performed using the web browser: at step 600, a user clicks on the raise hand button in the web page. At step 610, the application server processes the request to raise the participant's hand. The application server publishes to the message server that the caller has raised their hand. At step 620, the message server returns the xml provided by the application Server to all the JavaScript clients registered to listen for events of that specific conference call. At step 630, the JavaScript client then updates the web page to reflect that the caller has raised their hand.

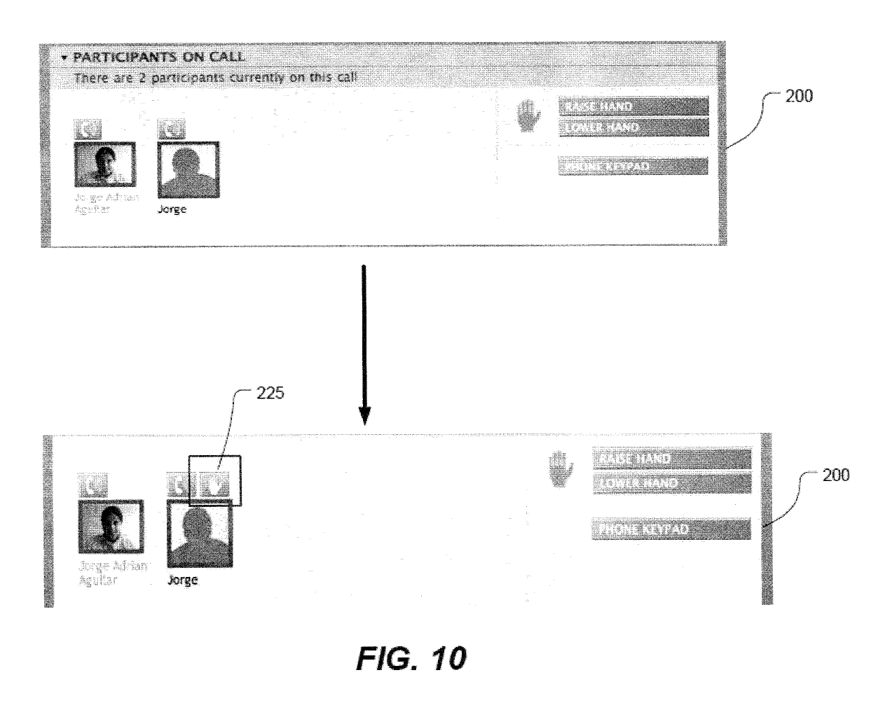

FIG. 10 presents two screenshots of an example web interface showing the dynamic changes to the interface when a user raises his hand. The page in the web application is dynamically updated to include a hand above Jorge's picture after he presses “*2” on his telephone. A raised hand icon 225 is shown in the bottom screenshot, again by way of example.

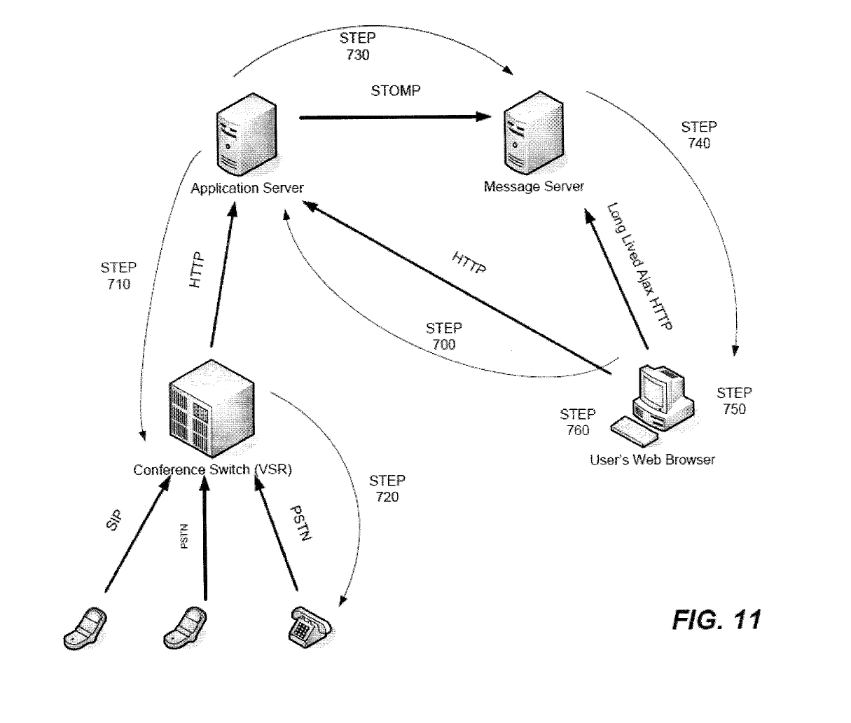

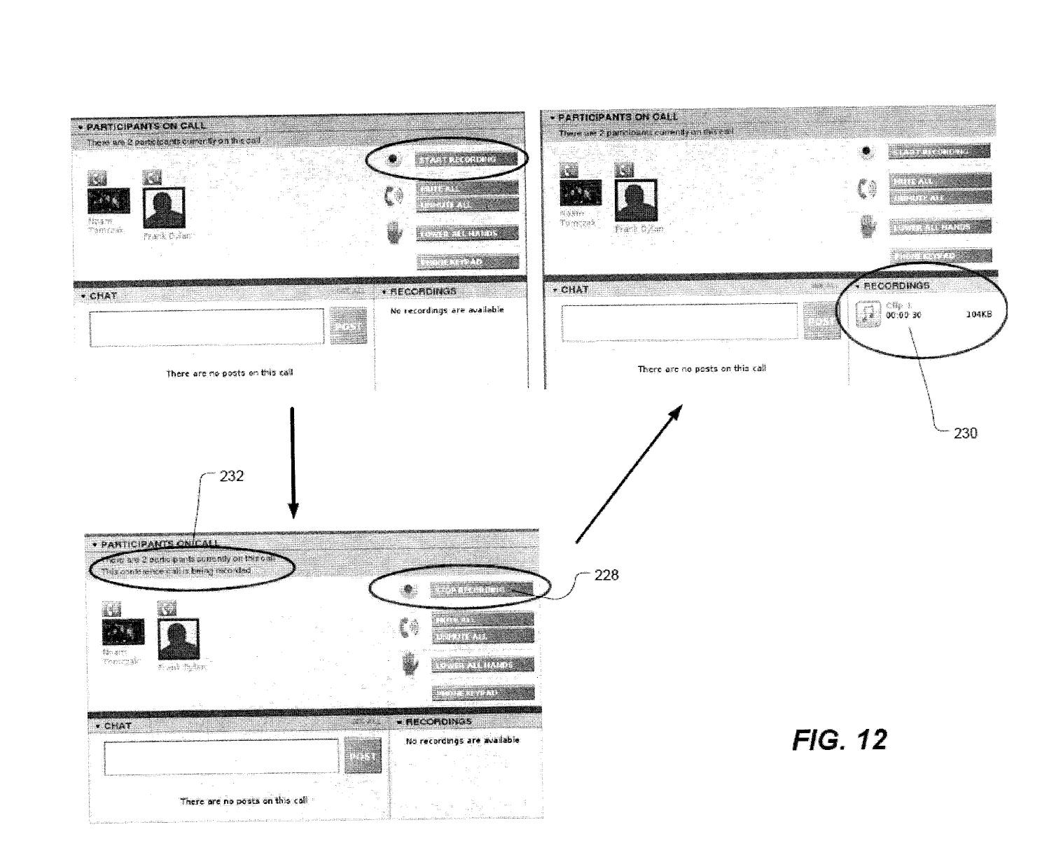

FIG. 11 schematically depicts the system data flow when a user initiates recording from the web browser client. As shown in this figure, this involves an initial step 700 in which the moderator of the call clicks on the “Start Recording” button in the web page. An Ajax request is sent to the Rails Server. The Rails server processes the command at step 710 and sends a “start recording” command to the VSR (conference bridge). At step 720, the VSR will play a prompt to all users on the conference call indicating that the call is being recorded. At step 730, the Rails server (application server) will publish that the recording has started. At step 740, ActiveMQ message server will publish to all connected clients listening for events of the conference call. At step 750, the JavaScript clients listening to events of this conference will update their web page to indicate that the recording has started. At step 760, by clicking the stop recording button on the web page the recording is stopped. The network flow is identical for this action. The web page is updated to indicate that the call is no longer being recorded. A link to the recording is dynamically added to the web page for users to download the recording. This download link is identified by reference numeral 230 in FIG. 12 (which presents various screenshots of how the interface changes when recording is initiated). FIG. 12 also depicts a start recording button 228 for initiating the recording from the web browser. A textual indication 232 (or graphical indication) that the call is being recorded can be provided as well.

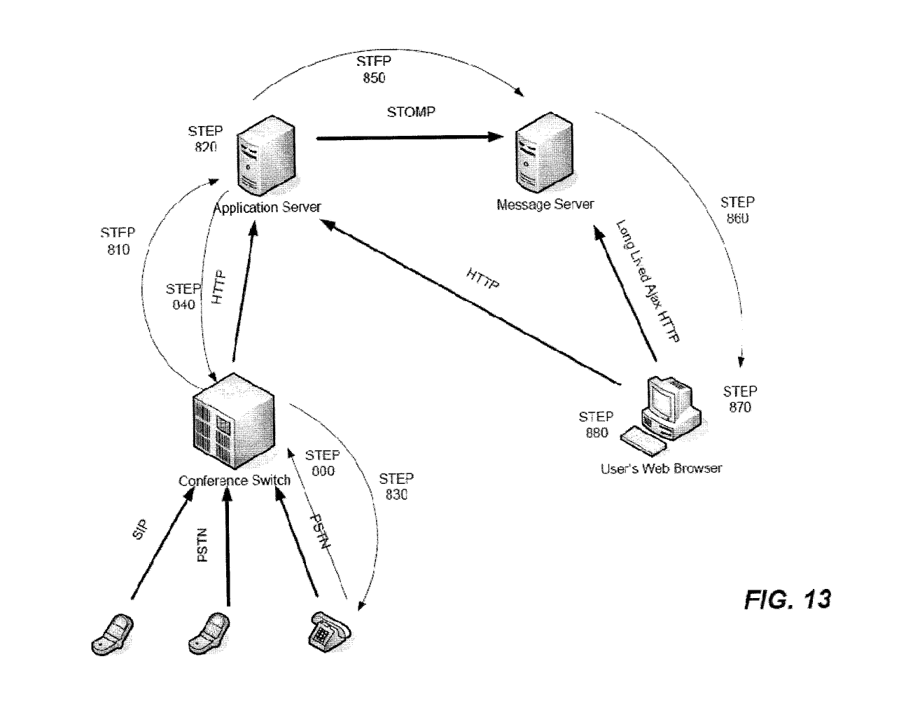

FIG. 13 schematically depicts the system data flow when a user initiates recording from the phone device. As shown in this figure, at step 800, the call moderator presses *7 on his phone device (or another predetermined key combination). At step 810, the conference switch send a DTMF event of “*7” to the application server. At step 820, the application server processes the event. It checks that the caller is in fact the moderator. At step 830, the VSR will play a prompt to all users on the conference call indicating that the call is being recorded. At step 840, the application server responds to the conference switch telling it to start the recording. At step 850, the application server will publish that the recording has started. At step 860, the ActiveMQ server (message server) will publish to all connected clients listening for events of the conference call. At step 870, the JavaScript clients listening to events of this conference will update their web page to indicate that the recording has started. At step 880, by pressing “*7” on his phone again the moderator can stop the recording. The network flow is identical for this action. The web page is updated to indicate that the call is no longer being recorded. A link to the recording is dynamically added to the web page for users to download the recording.

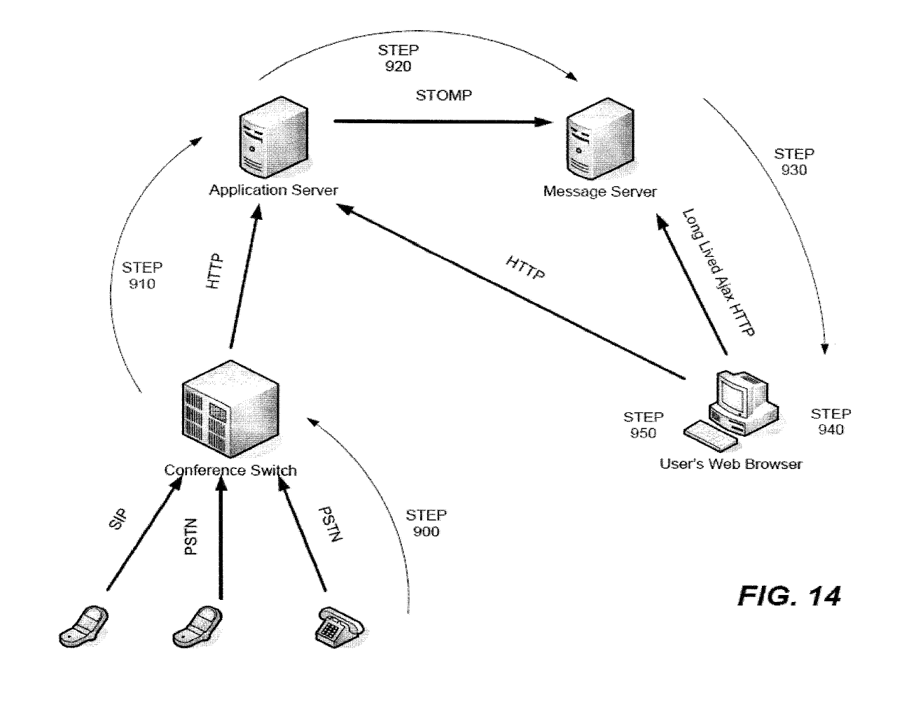

FIG. 14 schematically depicts the system data flow when the system detects who is talking. As depicted, the system detects who is talking when a caller actually starts talking into the phone device (step 900). The conference switch detects that the caller is talking and sends the event to the application server (step 910). The application server processes the event and publishes that the caller is now talking to the message server (step 920). The ActiveMQ server returns the XML provided by the application server to all the JavaScript clients registered to listen for events of that specific conference call (step 930). The JavaScript client then updates the web page to reflect that the caller is now talking (step 940). When the caller stops talking the same network is used to update the web page to reflect that the caller is not talking any more (step 950).

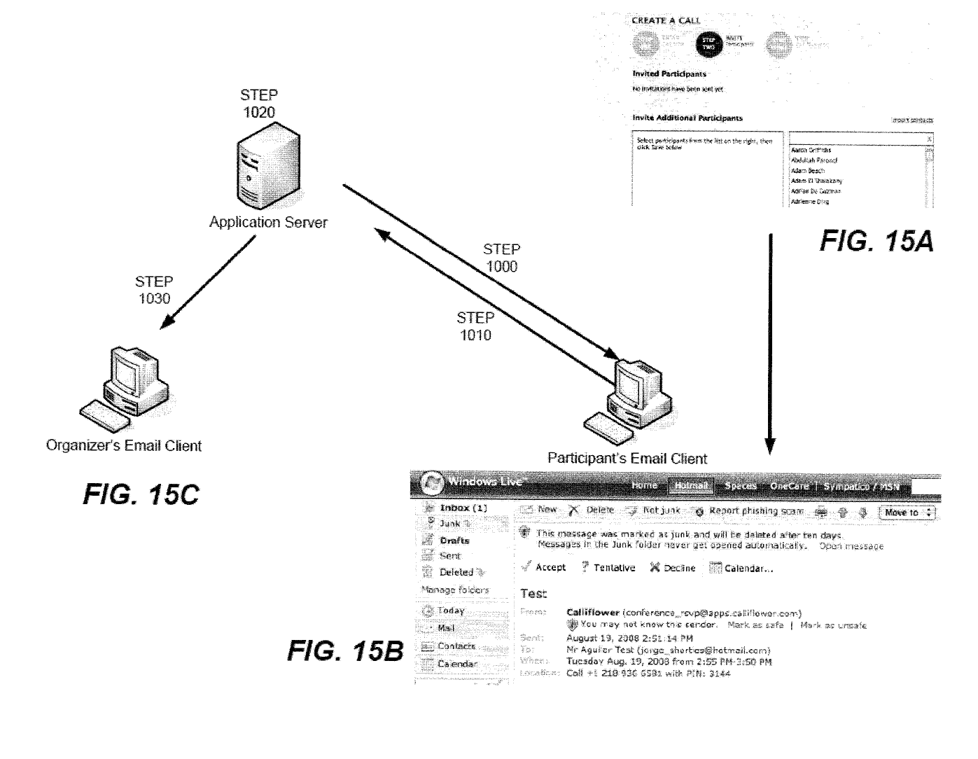

FIG. 15A is a screenshot of an example invitation to a conference call. FIG. 15B is a screenshot of an example acceptance screen for accepting/declining the invitation to the conference call. FIG. 15C schematically depicts the system data flow when invitations are sent and accepted. At step 1000, the application server sends an email invitation including an iCal to the participant. At step 1010, the participant RSVPs to the iCal using their email client. At step 1020, the application server parses the email response from the participant and updates their RSVP status in the application. If the participant included a personal message, that message is sent to the organizer of the conference call. At step 1030, the response from the participant is sent to the organizer's email client.

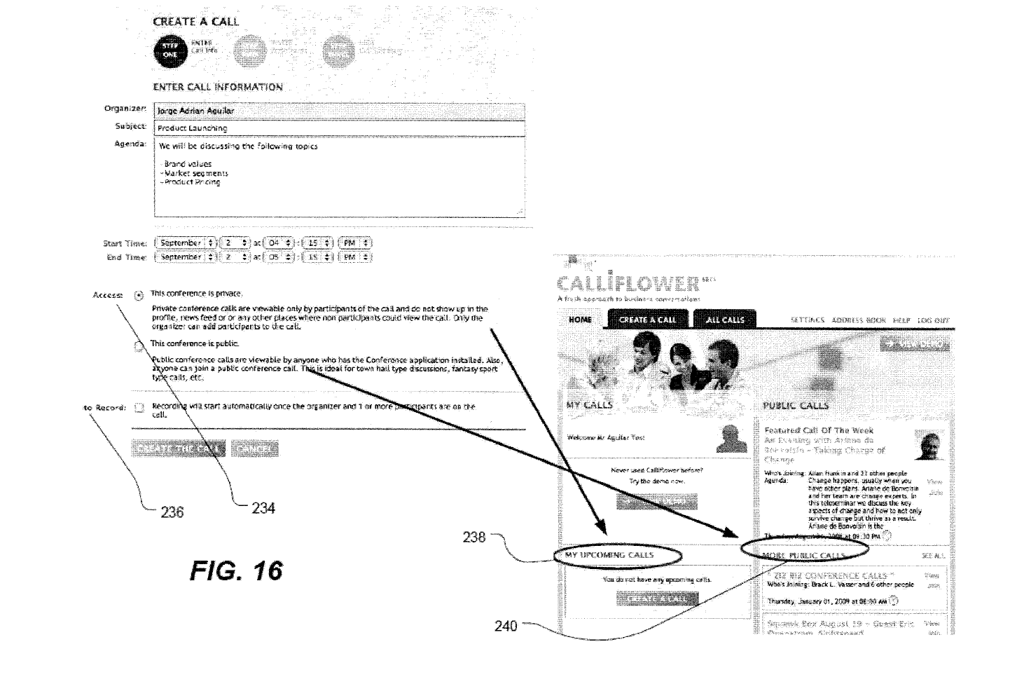

FIG. 16 are screenshots showing example interfaces during a conference call setup. An access control 234 feature can be provided to control whether the call is private or public. Private calls only appear in participant's upcoming call list and cannot be seen by other users of the system. Public calls are displayed to all users and can be joined by anyone. An auto-record feature 236 can be provided to automatically record the conference call. In the example interface on the right side, a list of upcoming private and public calls 238, 240 can also be provided to enable users to manage their conference calls effectively.

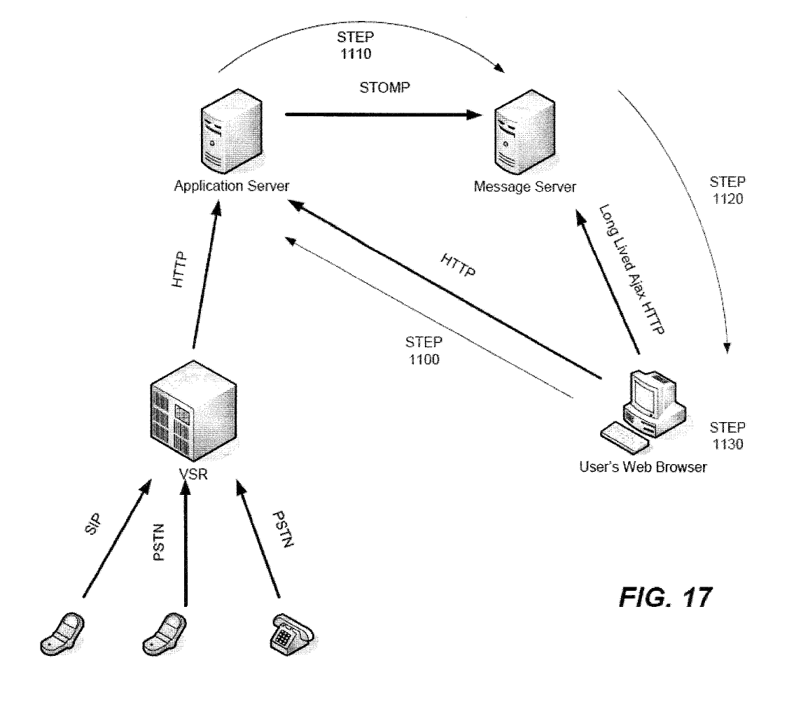

FIG. 17 schematically depicts the system data flow for live chat. At step 1100, a call participant types something into the chat window and hits the post button. At step 1110, the application server processes the request to post a chat message. The application server publishes to the message server, e.g. ActiveMQ server, that the caller posted a chat message. At step 1120, the ActiveMQ server returns the XML provided by the application server to all the JavaScript clients registered to listen for events of that specific conference call. At step 1130, the JavaScript client then updates the web page to reflect that the caller has added a chat message.

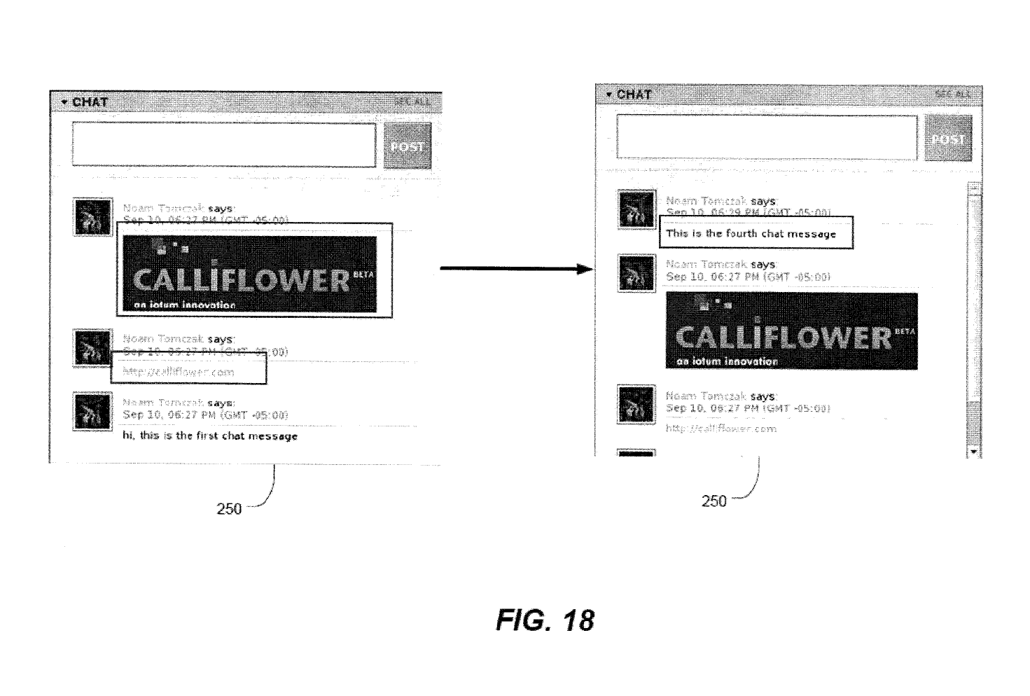

FIG. 18 are screenshots showing example chat interfaces 250. Chat messages containing URLs are automatically converted into HTML links for easy viewing of the content at the URL. Chat messages containing URLs to images are automatically converted into MTML IMG tags so the image is displayed.

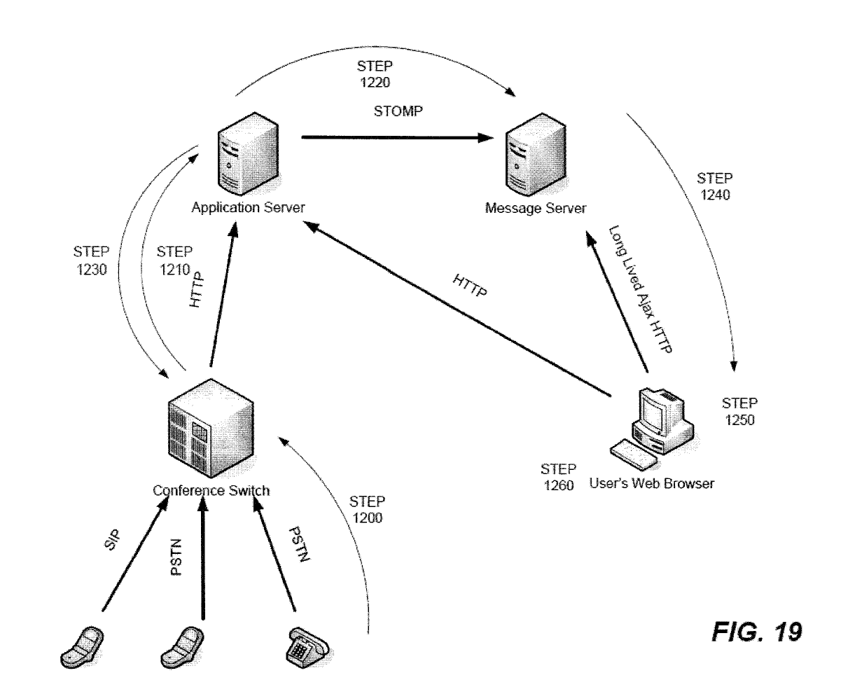

FIG. 19 schematically depicts the system data flow for muting a line from the phone device. As shown in this figure, at step 1200, a caller on a conference call presses “*6” (or another predetermined code or key combination) on their phone. At step 1210, the DTMF tones are caught by the VSR (conference bridge) and sent to the application server (e.g. Rails Server) via HTTP. At step 1220, the application server processes the “*4” determining that the caller wishes to mute their line. The application server publishes to the message server that the caller has muted his line. At step 1230, the application server returns a response code to the VSR telling it to mute the caller's line. At step 1240, the message server, e.g. ActiveMQ server, returns the XML provided by the application server (Rails Server) to all the JavaScript clients registered to listen for events for that specific conference call. At step 1250, the JavaScript client then updates the web page to reflect that the caller has muted his line. At step 1260, the caller can press “*6” again from their phone and his line will be un-muted. The network flow is identical for this action and the web page is updated in the same way to reflect that the line is no longer muted.

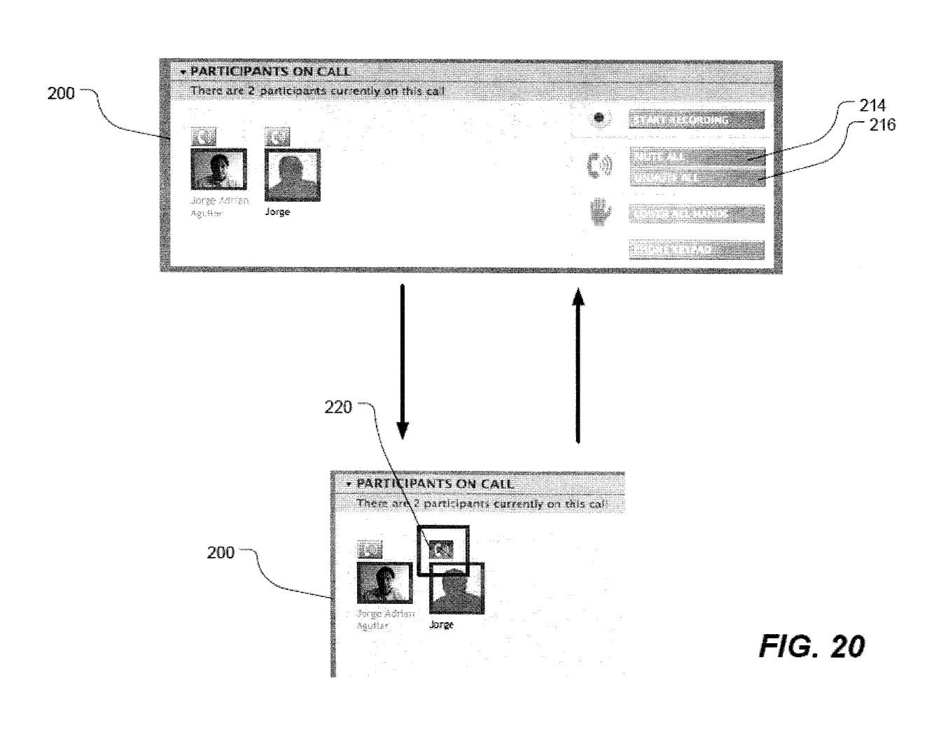

FIG. 20 are screenshots showing how the interfaces 200 are updated when a line is muted. The caller that pressed “*2” to mute his line has a red “X” (designated in the figure by reference numeral 220) superimposed over his phone icon that is displayed immediately above his picture and name. If the caller un-mutes his line by pressing “*2” from their phone, the phone icon will be returned to appear without the “X” though it. As will be appreciated, other symbols (other than the X) can be used to represent a muted line. Mute and un-mute buttons 214, 216 can be provided on the web interface as shown or in any other suitable manner.

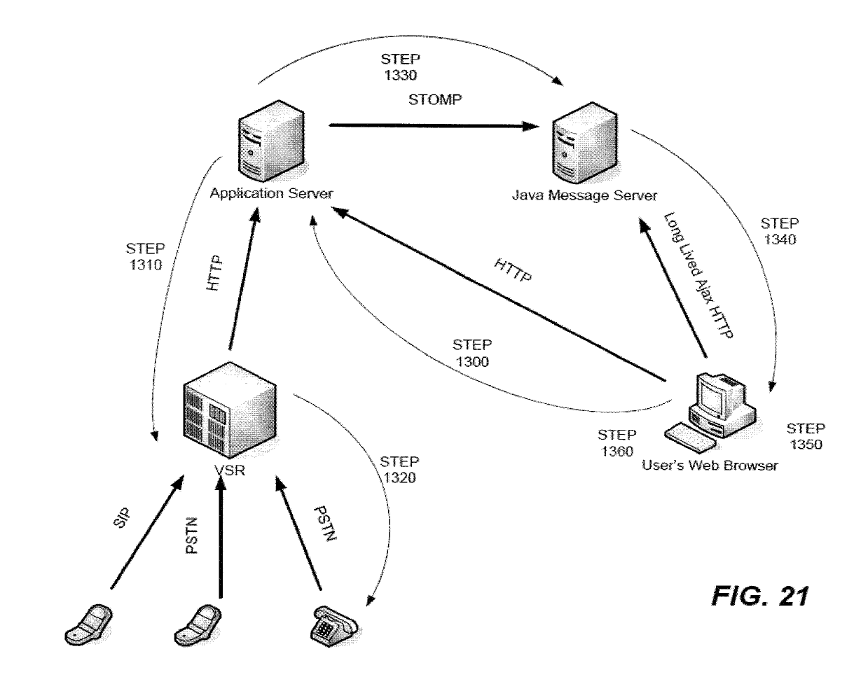

FIG. 21 schematically depicts the system data flow for muting and then un-muting a line using the web browser client. As depicted by way of example, an initial step 1300 triggers the process when a caller clicks the phone icon in the conference web page. An Ajax request is sent to the application server (e.g. the Rails Server). The Rails Server sends a “mute” command to the VSR (step 1310). The VSR will play a prompt to the user telling them that his line is muted (step 1320). The application server (e.g. Rails server) will publish that the caller has muted their line to the message server (e.g. ActiveMQ server) via STOMP or equivalent means (step 1330). At step 1340, the message server (e.g. ActiveMQ or equivalent) will publish to all connected clients who are listening for events emanating from the conference call. At step 1350, the web browser clients (e.g. JavaScript clients) listening to events of this conference will update their web page to indicate that the caller has muted his line. At step 1360, by clicking the phone icon again in the web page, the user can un-mute his or her line. The network flow (system data flow) is identical for this action. When completed the web page is updated to reflect that the caller's line is un-muted.

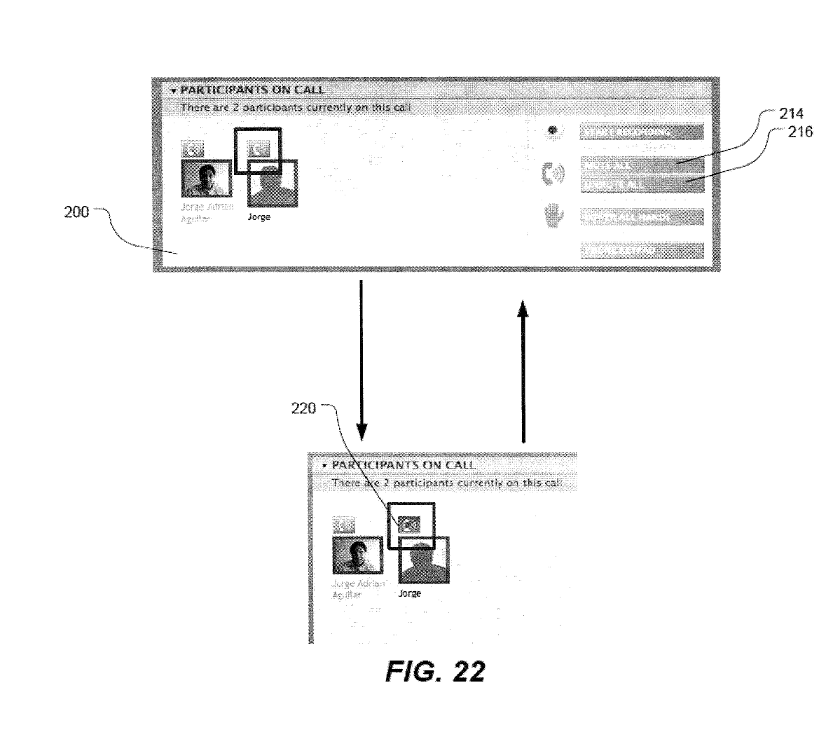

FIG. 22 are screenshots showing how the interfaces are updated when a line is muted and then un-muted using the web browser. Similar to the screenshots of FIG. 20, the interfaces 200 provide buttons 214, 216 for muting and un-muting a line. As described above, the caller who has muted his line has a red “X” added through their phone icon above their picture and name. If the caller un-mutes his line by clicking the phone icon again, the phone icon returns without the “X” through it.

From the foregoing, it should be apparent that in one or more embodiments of the present invention, the web interface at the browser client 50 graphically depicts (e.g. using icons, symbols, text, etc.) one or more of various status indicators for the participants. For example, when someone is joining a conference call, that participant's picture may turn green in the web application. For example, if someone leaves a conference call, that person's picture may turn red in the application. For example, if someone is “muting” or “un-muting” their line, then this can be depicted graphically. Likewise, also by way of example, if someone wishes to interject a comment, an icon showing a raised hand can be displayed. Also by way of example, starting and stopping the recording of the conference call can be displayed on the web interface. The digital sound file (e.g. a .WAV file) can then be saved, archived, played, e-mailed, edited, etc. As another example, messages can also be posted in a chat area of the web interface to further enhance interactivity amongst the participants to the conference call. The chatting function may include an icon or indicator to show that messages are waiting for a particular participant or that a particular participant is being invited into the chat zone.

A transcribing service (or transcript service) can also be provided using this technology. The transcript can be a written log of everything that was said. Optionally, the transcript can include a log of all conference call events (when participants enter, leave, hands raised and lowered, participants being muted and un-muted, messages posted in chat zone, etc.). As a variant, the system may be configured to log only a subset of these conference call events. As another variant, a filtering feature can be provided to enable participants to filter out certain types of conference call events to thus simplify the transcript.

In one specific embodiment, which is presented solely by way of example, the following technologies can be utilized to efficiently implement the system architecture described above: Ruby on Rails(™) can be utilized as the application server 20, Apache ActiveMQ can be used as the Message Broker i.e. “message server” 30. The ThinkEngine Networks VSR1000 can be used as the voice services router 20. The STOMP protocol can be used to provide easy messaging among various languages, platforms and brokers. As will be appreciated, other equipment, platforms, brokers, programming languages, frameworks can be utilized to implement this technology.

Computer Program Product

The methods described above can be implemented on one or more computer program products comprising code which when loaded into memory and executed on one or more processors of one or more computing devices is or are adapted to perform steps of communicating conference call events for a conference call from a voice services router to an application server, the voice services router being connected to phone devices, the phone devices furthermore being associated with respective web browser clients, communicating messages pertaining to the conference call events from the application server to a message server connected to both the application server and to the web browser clients, communicating the messages pertaining to the conference call events to the web browser clients, receiving at the application server one or more conference commands from the web browser clients, and communicating the one or more conference commands from the application server to the voice services router. The one or more computer program products can be uploaded to the various servers and web browser clients in order to configure this novel teleconferencing system.

From the foregoing disclosure, it should be apparent that this technology provides an innovative form of web-based conferencing. It is noteworthy that this technology can be implemented without using technologies like Flash or Java applets. The technology employs an application that runs in any web browser capable of standard HTML, CSS and JavaScript. This is an important factor, for example, because Flash does not run in the iPhone browser whereas this application would work fully.

An additional attribute of this technology is that it separates the business logic of a conference call from the conference switch, thereby enabling many of the innovative functionalities of this technology. Personal PIN codes, web controls etc would not be possible, or at least very difficult to implement efficiently, when the business logic is tied to the conference switch itself (as it is in the prior art). Therefore, this technology represents a very substantial improvement over pre-existing conferencing technologies.

The embodiments of the invention described above are intended to be exemplary only. As will be appreciated by those of ordinary skill in the art, to whom this specification is addressed, many obvious variations can be made to the embodiments present herein without departing from the spirit and scope of the invention. The scope of the exclusive right sought by the applicant is therefore intended to be limited solely by the appended claims.

1. A method of providing web-based teleconferencing, the method comprising:
connecting phone devices to a voice services router for a conference call, the phone devices being associated with respective web browser clients;
communicating conference call events for the conference call from the voice services router to an application server;
communicating messages pertaining to the conference call events from the application server to a message server connected to both the application server and to the web browser clients;
communicating the messages pertaining to the conference call events to the web browser clients;
receiving at the application server one or more conference commands from the web browser clients; and
communicating the one or more conference commands from the application server to the voice services router.

2. The method as claimed in claim 1 further comprising initial conference call setup steps of:
receiving a phone call from a party wishing to join the conference call at the voice services router;
prompting the party wishing to join the conference call for a conference call access code;
receiving and transmitting the conference call access code to the application server for validation of the access code;
if the access code is validated, transmitting a new caller joining signal to the message server which communicates the new caller joining signal to the web browser clients.

3. The method as claimed in claim 1 further comprising call-dropping steps of:
detecting at the voice services router that a phone device connected to the conference call has hung up, thus constituting a call-termination event;
communicating the call-termination event to the application server;
communicating a message pertaining to the call-termination event from the application server to the message server; and
communicating the message pertaining to the call-termination event to all the web browser clients associated with the conference call.

4. The method as claimed in claim 1 further comprising muting steps of:
receiving user input on a muting icon depicted on a web interface of the web browser client, thus constituting a mute command;
communicating the mute command to the application server;
communicating the mute command from the application server to the voice services router;
communicating a message pertaining to the mute command from the application server to the message server; and
communicating the message pertaining to the mute command to all web browser clients associated with the conference call.

5. The method as claimed in claim 1 further comprising providing a muting icon on a web interface for each of the web browser clients, the muting icon being adapted to receive user input to trigger communication of a muting command.

6. The method as claimed in claim 1 further comprising providing an interjection icon on a web interface for each of the web browser clients, the interjection icon being adapted to receive user input to trigger communication of an interjection command to indicate that a party wishes to speak.

7. The method as claimed in claim 1 further comprising providing a recording icon on a web interface for each of the web browser clients, the recording icon being adapted to receive user input to trigger communication of a recording command to indicate that the conference call is to be recorded.

8. The method as claimed in claim 1 further comprising providing a chat interface on the web interface for the web browser client to thereby enable parties to the conference call to exchange instant messages.

9. A system for enabling web-based teleconferencing, the system comprising:
a voice services router connected to phone devices with which are associated respective web browser clients;
an application server connected to the voice services router for receiving conference call events for a conference call from the voice services router and for transmitting the conference call events to a message server, the application server furthermore connected to the web browser clients associated with the phone devices for receiving conference commands from the web browser clients and for transmitting the conference commands received from the web browser clients to the voice services router;
wherein the message server is connected to both the application server and the web browser clients to thereby act as a message broker for receiving messages from the application server for the conference call and for communicating the messages for the conference call to the web browser clients.

10. The system as claimed in claim 9 wherein each web browser client presents a web interface depicting one or more icons for muting and un-muting.

11. The system as claimed in claim 9 wherein each web browser client presents a web interface depicting one or more icons for recording the conference call.

12. The system as claimed in claim 9 wherein the web browser client presents a web interface depicting one or more interjection icons for signalling that a party wishes to speak.

13. The system as claimed in claim 9 wherein each web browser client provides a chat interface for enabling parties to the conference call to exchange instant messages.

14. The system as claimed in claim 9 wherein each web browser client is adapted to interact with a social networking website to thereby add conferencing features to a web interface of the social networking website.

15. A computer program product comprising code which when loaded into memory and executed on one or more processors of one or more computing devices is adapted to perform steps of:
communicating conference call events for a conference call from a voice services router to an application server, the voice services router being connected to phone devices, the phone devices furthermore being associated with respective web browser clients;
communicating messages pertaining to the conference call events from the application server to a message server connected to both the application server and to the web browser clients;
communicating the messages pertaining to the conference call events to the web browser clients;
receiving at the application server one or more conference commands from the web browser clients; and
communicating the one or more conference commands from the application server to the voice services router.
